(19) United States
(12) Patent Application Publication
(10) Pub. No.: US 2022/0356764 A1
(43) Pub. Date: Nov. 10, 2022

(54) Ladder Arch Support Extension

(71) Applicant: Richard J. Boyington, Vero Beach, FL (US)

(72) Inventor: Richard J. Boyington, Vero Beach, FL (US)

(21) Appl. No.: 17/307,685

(22) Filed: May 4, 2021

(51) Int. Cl. E06C 7/16

(52) U.S. Cl. CPC E06C 7/16

(57) ABSTRACT

The present invention includes an accessory step extender apparatus to extend the area that a ladder user's foot may be placed, so that a larger portion of the ladder user's foot may be placed down to increase stability. The apparatus is comprised of at least two hanging arms, a horizontal stepping platform, and at least two platform support rods. The apparatus is hung by the hanging rods on one rung of a ladder and by the platform support rods on a second, lower rung of the ladder. When the apparatus is hung, the horizontal stepping platform extends towards the interior of the ladder (or back if you are facing the ladder) even with or approximately even with the second rung of the ladder, thus extending the area where the ladder user's foot or feet may be placed.

### BACKGROUND OF THE INVENTION

According to the U.S. Consumer Products Safety Commission, in 2018 more than 580,000 people in the United States were injured due to falls from ladders, resulting in at least 300 deaths. The rungs of most extension ladders sold in the United States are typically about 2 inches, or about 5 cm deep, wherein the average foot length of a North American Caucasian mail is 26.3 cm, or approximately 10.4 inches. This leads to inherent instability in the user of the ladder trying to balance on rungs that are significantly smaller than the user's feet.

Various embodiments of the present invention recognize and address the foregoing considerations, and others, of prior art devices, by providing an apparatus that may be hung on an existing ladder that will provide a larger and more stable surface for the user to stand on.

### BRIEF SUMMARY OF THE INVENTION

This Summary is provided to introduce a selection of concepts in a simplified form that are further described below in the Detailed Description. This Summary is not intended to be used to limit the scope of the claimed subject matter.

The present invention includes an accessory step extender apparatus comprised of at least two hanging arms, a horizontal stepping platform, and at least two platform support rods. In embodiments of the invention, at least two of the platform support rods are attached to the horizontal stepping platform, and at least two of the hanging rods are attached to the horizontal stepping platform directly, or the platform support rods, which themselves are attached to the horizontal stepping platform. Such apparatus is hung by the hanging rods on one rung of a ladder and by the platform support rods on a second, lower rung of the ladder. When the apparatus is hung, the horizontal stepping platform extends towards the interior of the ladder (or back if you are facing the ladder) even with or approximately even with the second rung of the ladder, thus extending the area where the ladder user's foot or feet may be placed. This extension allows for the user to not only place the ball of its foot down, but also the toe box, ball, and arch of the foot, thus providing better stability for the ladder user.

### BRIEF DESCRIPTION OF THE SEVERAL VIEWS OF THE DRAWINGS

Various embodiments of the disclosure will be described below. In the course of the description, reference will be made to the accompanying drawings, which are not necessarily drawn to scale. References to “left,” “right,” “front,” and “back” are taken from the perspective of a user facing a positioned ladder.

FIG. 1 is a right back top perspective view of a ladder accessory apparatus according to one embodiment of the present invention, in the extended position.

FIG. 2 is a right back top perspective view of the ladder accessory according to the embodiment of the invention shown in FIG. 1, in the extended position as shown positioned on a ladder (dotted lines).

FIG. 3 is a top view of the embodiment of the invention of FIG. 1 in the extended position, shown without a ladder.

FIG. 4 is a left side view of the embodiment of the invention shown in FIG. 1 in the extended position and shown without a ladder.

FIG. 5 is a back view of the embodiment of the invention shown in FIG. 1 in the extended position without a ladder.

FIG. 6 is a right side view of the embodiment of the invention shown in FIG. 1 in the extended position and shown without a ladder.

FIG. 7 is a front view of the embodiment of the invention shown in FIG. 1 in the extended position without a ladder.

FIG. 8 is a left side view of the embodiment of the invention shown in FIG. 1 shown positioned on a ladder.

FIG. 9 is a front view of the embodiment of the invention shown in FIG. 1 shown positioned on a ladder.

FIG. 10 is a top view of the embodiment of the invention shown in FIG. 1 shown positioned on a ladder.

FIG. 11 is a back view of the embodiment of the invention shown in FIG. 1 shown positioned on a ladder.

FIG. 12 is a right top perspective view of an embodiment of the invention shown with the platform folded up position and without a ladder.

FIG. 13 is a right side view of the embodiment of the invention shown in FIG. 12, in the folded position and without a ladder.

FIG. 14 is a top view of the embodiment of the invention shown in FIG. 14, in the folded position and without a ladder.

### DETAILED DESCRIPTION OF THE PREFERRED EMBODIMENTS OF THE INVENTION

Various embodiments will now be described more fully hereinafter with reference to the accompanying drawings. It should be understood that the concepts disclosed herein may be embodied in many different forms and should not be construed as limited to the embodiments set forth herein. Rather, these embodiments are provided so that this disclosure will be thorough and complete, and will fully convey the scope of the disclosure to those skilled in the art. Like numbers refer to like elements throughout.

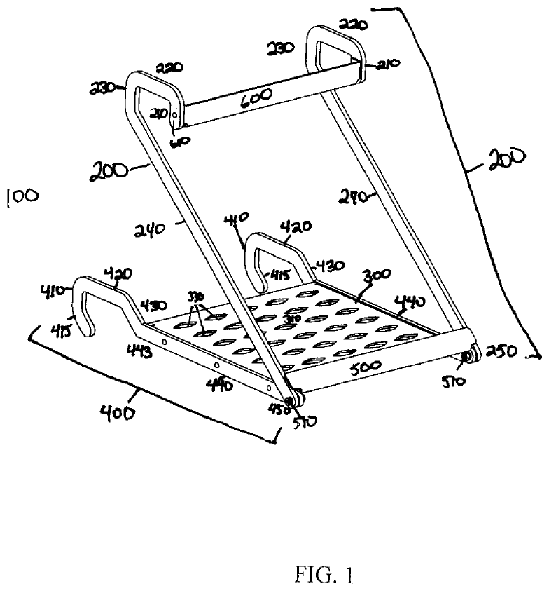

Referring now to FIGS. 1-14, aspects of the ladder accessory step extender apparatus 100 will be discussed in detail. According to various embodiments, the accessory step extender apparatus 100 includes at least two hanging arms 200, a horizontal stepping platform 300, and at least two platform support rods 400. At least two of the platform support rods 400 are attached to the horizontal stepping platform 300, and at least two of the hanging rods are attached to the horizontal stepping platform 300 directly, or the platform support rods 400, which themselves are attached to the horizontal stepping platform.

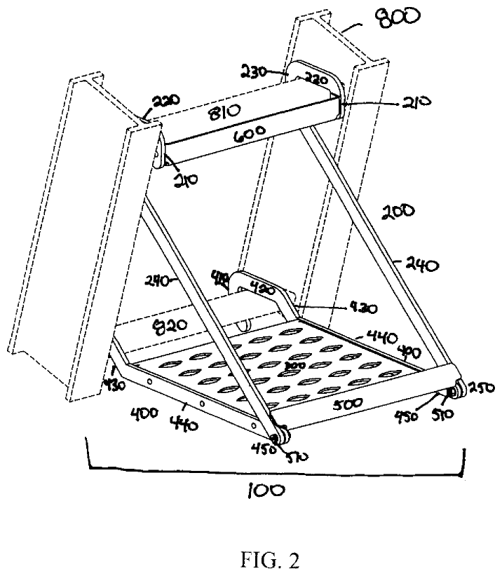

As shown in the embodiment in FIGS. 1-2 each of the at least two hanging arms 200 is comprised of a vertical interior extension 210 which connects to an arm horizontal step overlay 220 which connects to a vertical exterior extension 230, and which connects to a diagonal hanging extension 240. At the opposite end from the connection to the vertical extender extension 230 the diagonal hanging extension 240 terminates at its platform attachment end 250 of the hanging arm 200. In the embodiments shown in FIGS. 1-14, each of the vertical interior extension 210, arm horizontal step overlay extension 220, vertical exterior extension 230, and diagonal hanging extension 240 are parts of a unitary piece, which is bent to form the particular extension. However, in other embodiments, one or more of these may be separate components which are connected to each other using various connection methods, such as various types of welding, rivets, screws, bolts, molded inserts, bonding, and other means of connection. In preferred embodiments, each hanging arm is a unitary molded or bent piece.

The invention is further comprised of a horizontal stepping platform 300. The horizontal stepping platform 300, when the apparatus is engaged, is intended to bear the weight of the user's foot or feet, either entirely or in addition to the rung 820 on which the platform support rods 400 are hung. The horizontal stepping platform 300 in the embodiment shown in FIGS. 1-11 is of rectangular shape, but in other embodiments, it may be of other shapes, including but not limited to square, hexagonal, semioval, and other appropriate shapes. As shown in FIGS. 1-2, the horizontal stepping platform 300 is comprised of a top stepping surface 310, and a bottom surface 350. As shown in the embodiments in FIGS. 1-14, the horizontal stepping platform may optionally include multiple holes 330, which may be pierced, bored, punched, molded, or included through other methods. Such holes 330 may include hole extensions that may extend beyond the bottom surface 350 of the horizontal stepping platform. Such holes 330 may aid in drainage of liquids on the top stepping surface 310 of the horizontal stepping platform and/or may aid in traction with the user's shoes or feet.

As shown in FIG. 1 and other Figures, embodiments of the invention are further comprised of two or more platform support rods 400. The embodiments shown in the Figures have two platform support rods 400, with one platform support rod attached to each of the two sides of the horizontal stepping platform 300.

When there are two platform support rods 400, each platform support rod is comprised of at least a horizontal platform side support 440, a rod interior extension 430, a rod horizontal step overlay 420, and a rod exterior vertical extension 410. Each horizontal platform side support 440 is comprised of an arm attachment end 450 and a step end 443 In each of the two platform support rods 400, the rod interior extension 430 connects to or extends from the step end 443 of the horizontal platform side support 440. In the embodiment shown in FIGS. 1-2, the two platform support rods 400 are further comprised of a rung under support 415, which in this embodiment extends from the end of the exterior vertical extension 410 and is angled diagonal from to extend to a certain extent under the rung on which the platform support rod 400 hangs.

One of each of the two platform rods 400 is either attached to (as shown in FIG. 1) or integrated with each outer side 360, 370 of the horizontal stepping platform 300 at the horizontal platform side support 440. Such attachment of the horizontal platform side support 440 to the outer side 360 or 370 of the horizontal stepping platform 300 may be by any reasonable attachment or connection methods, including but not limited such as various types of welding, rivets, screws, bolts, molded inserts, bonding, and other means of connection. In a preferred embodiment, as shown in FIGS. 1-2, each horizontal side support is riveted to an outer side of the horizontal stepping platform 300.

As shown in FIG. 1, each of the two side platform support rods 400 is attached to a respective hanging arm 200 at the platform attachment end 250 of the hanging arm 200 and the arm extension end 450 of the platform support rod 400. Such attachment may be through a static means of attachment, including but not limited to welding, rivets, thermal attachments, and the like. In preferred embodiments, such as those shown at least in FIGS. 1-2, and 12-14, the platform attachment end 250 and the arm extension end 450 are connected using a means that allows for movement 510, so that the hanging arms 200 may be moved into various positions with respect to the horizontal stepping platform 300. Such means may include using threaded rods with lock nuts, screw, rivets, threaded bolts with nuts and washers, and other similar mechanisms.

In preferred embodiments, which will be further explained in relation to FIGS. 1-14 below, the two hanging arms 200 may be folded down such that in the folded position the diagonal hanging extension 240 of each hanging arm rests next to the respective corresponding horizontal platform side support 440 of the two platform support rods 400.

The ladder 800 is not a part of the embodiment of the apparatus 100 itself, but for the purpose of illustrating how the apparatus is used in conjunction with a ladder, various components of the ladder are described herein as well. When referring to the interior end of a rung of a ladder, we are herein referring to the long edge of the rung that, in ordinary use, the ladder climber's toe would be closest to. When referring to the exterior end of a rung of a ladder, we are herein referring to the long edge of the rung that, in ordinary use, the ladder climber's heel would be closest to.

As shown in FIG. 2, when the apparatus is shown as applied to an extension ladder, the hanging arms 200 of the apparatus are hung on a first rung 810 of the ladder 800. When the apparatus 100 is used on a ladder 800, the arm horizontal step overlay extension 220 of each hanging arm 200 rests on top of the first rung 810 of the ladder. The vertical interior extension 210 rests along or near the interior end of the first rung 810. The vertical exterior extension 230 rests along or near the exterior end of the first rung 810.

As further shown in FIG. 2, when the apparatus 100 is used with a ladder 800, the rod horizontal step overlay 420 of each side platform support rod 400 rests on top of the second rung 820 of the ladder. At least a portion of each rod interior extension 430 rests at or near the interior end of the second rung 820 of the ladder. Each rod exterior vertical extension 410 rests at or near the exterior end of the second rung 820 of the ladder.

In the embodiment shown in FIG. 2, the optional rung under support 415, which extends from the rod exterior vertical extension 410 extends down below at least part of the second rung. This optional rung under support 415 can provide positional protection on the ladder against an upward force, such as a shoe or foot sticking to the horizontal stepping platform 300 and lifting the apparatus off of the ladder when such is not intended.

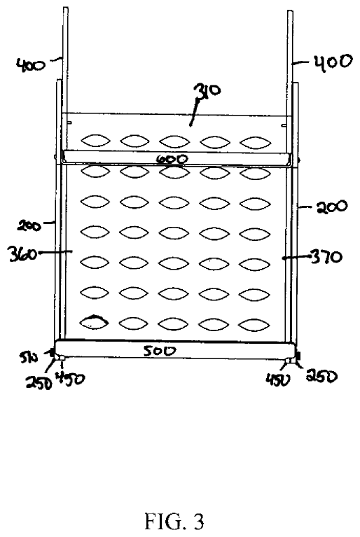

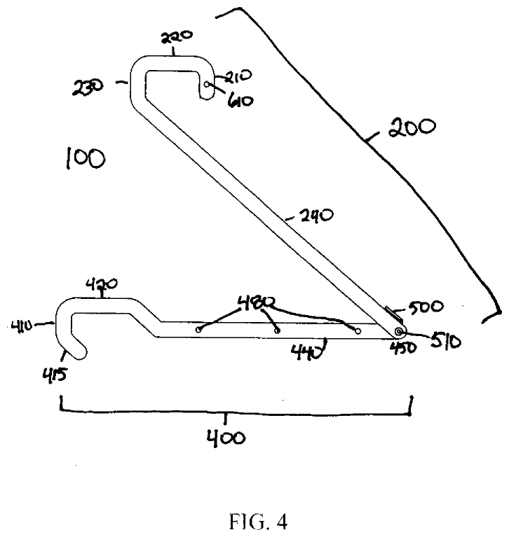

FIG. 3 shows a top view of the embodiment of the invention shown in FIG. 1 when extended but not positioned on a ladder. FIG. 4 illustrates a side view of the embodiment of the invention shown in FIG. 1 as extended but not applied to a ladder, and the other side view of the same embodiment is illustrated in FIG. 6.

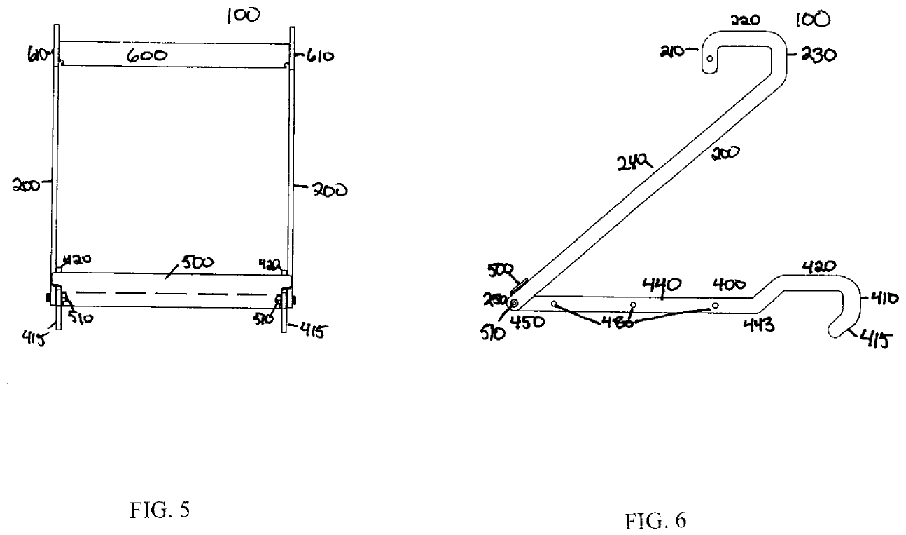

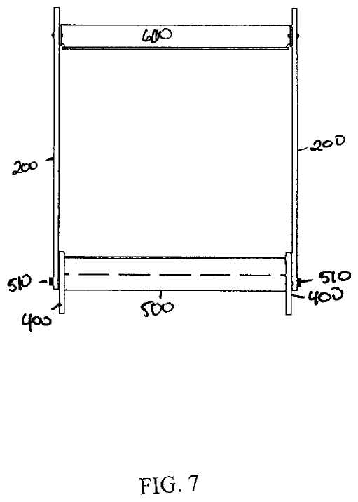

FIG. 5 is a back view of the embodiment of the invention shown in FIG. 1 in the extended position without a ladder. FIG. 7 is a front view of the embodiment of the invention shown in FIG. 1 in the extended position without a ladder.

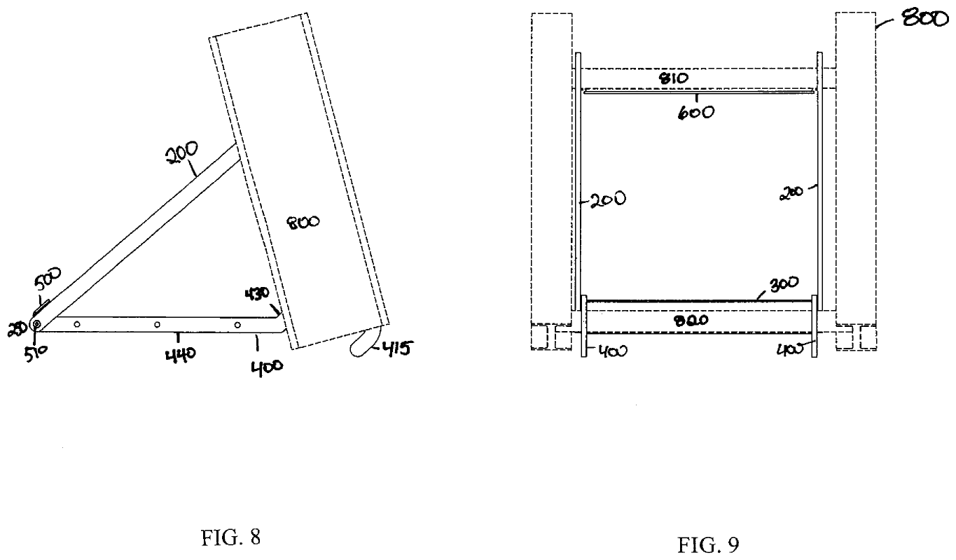

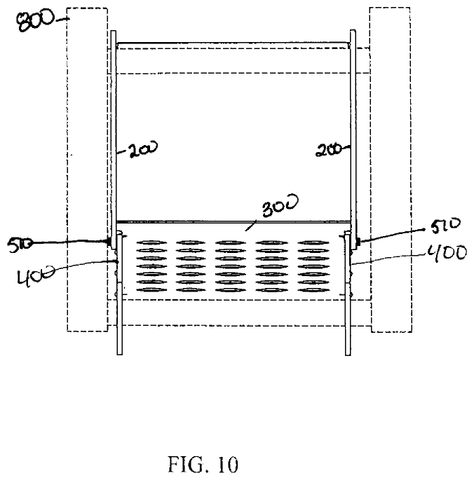

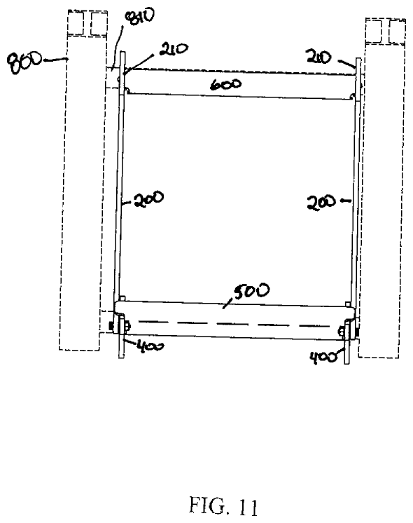

FIG. 8 is a left side view of the embodiment of the invention shown in FIG. 1 shown positioned on an extension ladder. FIG. 9 is a front view of the embodiment of the invention shown in FIG. 1 shown positioned on a ladder. FIG. 10 is a top view of the embodiment of the invention shown in FIG. 1 shown positioned on a ladder. FIG. 11 is a back view of the embodiment of the invention shown in FIG. 1 shown positioned on a ladder.

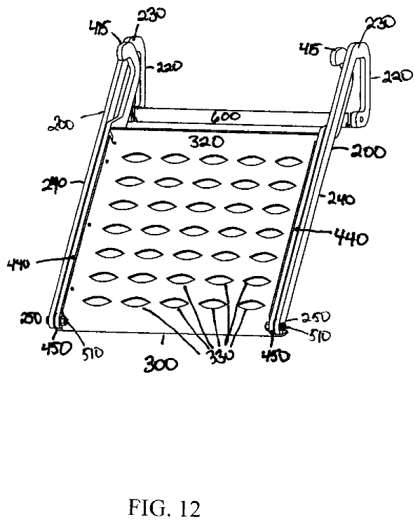

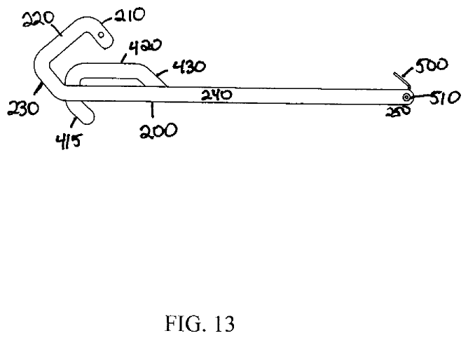

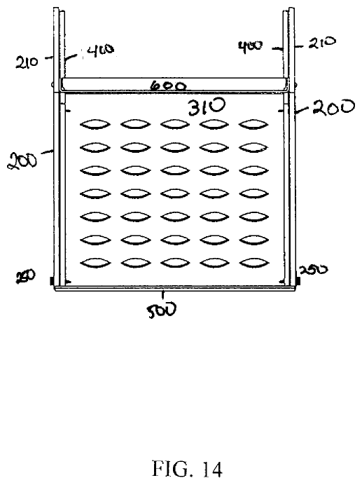

FIG. 12 is a right top perspective view of an embodiment of the invention shown with the platform folded up position and without a ladder. FIG. 13 is a right side view of the embodiment of the invention shown in FIG. 12, in the folded position and without a ladder. FIG. 14 is a top view of the embodiment of the invention shown in FIG. 14, in the folded position and without a ladder.

In the embodiments shown in FIGS. 1-14, the apparatus is further comprised of a first rung lateral support 600 which extends between the respective vertical interior extensions 210 of each of the two side hanging arms 200. The first rung lateral support can serve as a handle when the user is carrying an apparatus prior to applying it to a ladder. Such lateral support may an integrated part between the respective vertical interior extensions, and if the apparatus constructed using a molding technique, it may be molded as a unitary part with the two side hanging arms. In preferred embodiments, the two side hanging arms 200 and the first rung lateral support 600 are a unitary piece made from injection-molded fiberglass. If it is not manufactured as a unitary part with the side hanging arms 200, then the first rung lateral support 600 may be attached to the respective side hanging arms 200 using any known attachment mechanism, including but not limited to threaded bolts, rivets, welding, screws, molded inserts, bonding, and thermal attachment. As shown the lateral support 600 is attached to the respective vertical interior extensions using rivets.

In the embodiments shown in FIGS. 1-14, the apparatus is further comprised of an optional arm stepping platform lateral stop 500 which extends between the two respective diagonal hanging extensions 240 near the platform attachment end 250 of each of the two side hanging arms 200. In this embodiment, such arm stepping platform lateral stop 500 is positioned such that it is near the interior or user's toe end of the horizontal stepping platform 300 and on the side of the horizontal stepping platform opposite the second rung 820. In embodiments that fold to a closed position, such as shown in FIG. 13, the arm stepping platform lateral stop can act as a stop so that when extending the apparatus, it does not extend past a desirable angle, to the fully vertical position, or flip over itself. In embodiments for folding apparatuses that include the optional arm stepping platform lateral stop 500, it is positioned such that the maximum extension angle between the respective corresponding platform support rods 400 and hanging arms 200 is less than 70 degrees, more preferably less than or equal to 60 degrees, even more preferable less than 55 degrees, and in most uses and most preferable less than or equal to 50 degrees. Other components other than the shown arm stepping platform lateral stop 500 may alternately optionally be used to prevent overextension in embodiments that are capable of being folded, including but not limited to using one or more flexible straps that connect the corresponding platform support rods to the corresponding hanging arms, as well as mechanical limits put on the folding mechanism 510.

As referenced above, in a preferred embodiment of the invention, the platform attachment end 250 and the arm extension end 450 are connected using a means that allows for movement, so that the hanging arms 200 may be moved into various positions with respect to the horizontal stepping platform 300. FIGS. 12-14 illustrate an apparatus according to one such embodiment of the invention, whereas the horizontal stepping platform 300 is fully folded when not in use, such that the diagonal hanging extensions 240 of the hanging arms 200 are fully folded so that they are next to and run along the horizontal platform side supports 440 of the side platform support rods 400, and the bottom surface 320 of the horizontal stepping platform 300 is shown. Folding this and similar embodiments of the invention in this manner will allow both for easy carrying and compact storage of the apparatus when not in use.

In some optional embodiments of the invention, the two side platform support rods 400 may each be integrated with in a unitary piece with the horizontal stepping platform 300, such that the horizontal side supports 440 of each side platform support rod is each outer side 360, 370 of the horizontal stepping platform 300.

In other embodiments of the invention, additional platform support rods (in addition to the two on the sides of the horizontal stepping platform) may be included and attached to the bottom surface 350 of the horizontal stepping platform 300 to provide more support. Such additional platform support rods may be comprised of all of the components described herein, or may be comprised of fewer than all of the components described herein. In one embodiment of the invention, at least a third platform support rod is attached to the bottom surface 350 of the horizontal stepping platform. Further embodiments which are not shown in the Figures may include additional platform supports, which may optionally extend horizontally across the bottom surface 350 of the platform support rod, i.e. from the first outer side 360 to the second outer side 370.

In other embodiments of the invention not shown in the drawings, the horizontal stepping platform 300 may not include any holes. The top stepping surface 310 horizontal stepping platform 300 may optionally be a smooth surface with no holes or indentations. The top stepping surface 310 of the horizontal stepping platform 300 may also optionally include one or more other tractional features, including but not limited to nubs, ridges, grooves, spikes, indentations, or other features to improve the traction of the user's feet on the top surface 310 of the horizontal stepping platform.

The optional holes 330 of the horizontal stepping platform 330 may, as shown in the Figures be eye-shaped. However, such optional holes may have other alternative shapes, including but not limited to round, oval oblong, triangular, square, rectangular, pentagonal, hexagonal, or other regular polygon or irregular shapes.

In apparatuses according to the invention, the respective lengths of the arms 200 and side platform support rods 400 are such that the arms and the side platform support rods 400 may be hung on successive rungs of a ladder when the embodiment of the invention is it its extended position. In preferred embodiments, the length of the diagonal hanging extensions 240 is 13.5 to 14.5 inches, preferably 14 inches. The preferred total length of each hanging arm 200 is 15.5 inches to 16.5 inches in total length, more preferably about 16 inches, and most preferably 16 inches.

In preferred embodiments of the invention, the arm horizontal step overlay extension 220 and rod horizontal step overlay 420 each have a respective length such that the apparatus may be used on most movable standard step ladders, extension ladders, and pylon ladders. However, this statement is not meant to limit embodiments of the invention for use only with such ladders or devices.

The respective distance between the two hanging arms 200 with respect to each other and the distance between each of the respective side platform support rods 400 with respect to each other must be such that the apparatus in accordance with the invention fits between the side vertical supports of a ladder, and onto the rungs themselves. Thus, the apparatus in accordance with the invention must be narrower than the ladder such apparatus is used on. In preferred embodiments of the invention, the interior distance between the respective hanging arms is between 12⅜ inches and 12⅝ inches, more preferably about 12½ inches. Similarly, the preferred width of the horizontal stepping platform 300 is 12.5 inches.

The horizontal stepping platform 300 should be of sufficient size to effectively extend the second rung 820 of the ladder so that more of a user's foot may be placed on the 300 than is typically placed on a rung of a ladder. The horizontal stepping platform is preferably of sufficient size such that an adult's entire toe box, ball of foot portion of the shoe, and part of the arch area of the user's shoe will fit well within the platform, if used by an adult. As shown in the embodiments in the figures and as described in this paragraph, an adult male user with a US size 14 shoe could place his foot on the extension device and it would still make for a comfortable step that supports not only the ball of the foot, but the toe and arch portion as well. In preferred embodiments, the depth of the horizontal stepping platform as measured from the arm attachment end 450 to the step end 443 is between 8 and 11 inches, more preferably between 9 and 10 inches, most preferably 9.5 inches. The thickness of the horizontal stepping platform should maintain a balance between thinness, for ease of use, and mechanical support to enable support of any reasonable adult user's weight. It should be of appropriate materials and thickness to be able to support at least a 250 pound person, more preferably at least 300 pounds. The horizontal stepping platform 300 may be made of any variety of rigid materials, including steel, fiberglass, other metals, and rigid formed plastic. In preferred embodiments, the horizontal stepping platform 300 is composed of ½ inch honeycomb fiberglass.

In preferred embodiments of the invention, the angles of vertical interior extension 210, arm horizontal step overlay extension 220, vertical exterior extension 230, diagonal hanging extension 240 with respect to each other are such that and the angles of the rod interior extension 430, the rod horizontal step overlay 420, and rod exterior vertical extension 410 with respect to each other are such that when the apparatus is positioned on the ladder 800, the platform 300 is even with the second rung 820 or parallel to the ground, or both. This may be accomplished with both rounded shapes of vertical interior extension 210 and vertical exterior extension 230 and more squared-off shapes. In preferred embodiments, the angle between the vertical interior extension 210 and horizontal step overlay extension on a hanging arm 200 and the arm horizontal step overlay extension 220 is 85 to 95 degrees, more preferably about 90 degrees. In preferred embodiments, the angle between the arm horizontal step overlay extension 220 and vertical exterior extension 230 is 85 to 95 degrees, more preferably about 90 degrees. In preferred embodiments, the angle between vertical exterior extension 230 and diagonal hanging extension 240 is between 120 and 130 degrees, more preferably about 130 degrees. In embodiments of the invention with two hanging arms 200, both hanging arms should be of similar or identical dimensions and with similar or identical angles.

In preferred embodiments of the invention, the length of each rod horizontal step overlay 420 is between 1⅞ inches and 2⅜ inches, more preferably 2 to 2¼ inches, most preferably 2¼ inches. In preferred embodiments of the invention, the length of each arm horizontal step overlay extension 220 is between 1⅞ inches and 2⅜ inches, more preferably 2 to 2¼ inches, most preferably 2¼ inches.

The various components of embodiments of the apparatus according to the invention may be made of different materials that possess the necessary strength and rigidity to support at least 250 pounds of weight. Thus, in preferred embodiments of the invention, the hanging arms 200, horizontal stepping platform 300, and side platform support rods 400 are made of aluminum, steel, reinforced polyester resin, and/or fiberglass, more preferably aluminum or fiberglass, most preferably fiberglass.

I claim:

1. An accessory step extender apparatus for a ladder, said apparatus comprising:
a. at least two hanging arms, each hanging arm comprising:
i. a vertical interior extension, which is connected to
ii. an arm horizontal step overlay extension, which is further connected to
iii. a vertical exterior extension, which is further connected to
ii. a diagonal hanging extension, which terminates in
iii. a platform attachment end;
b. a horizontal stepping platform comprising a top surface and a bottom surface and a first rod side, a second rod side, a toe side, and a step side, said platform extending tangential to the hanging arms, and
d. at least two platform support rods, a first rod and a second rod, each platform support rod comprising
i. a horizontal platform side support, each horizontal platform side support comprising an arm attachment end and a step end, said step in connected to
ii. a rod interior extension, which is connected to
iii. a rod horizontal step overlay extension, which is connected to
iv. a rod exterior vertical extension.
wherein the platform attachment end of the first hanging arm is attached to the arm attachment end of the first platform support rod, and the platform attachment end of the second hanging arm is attached to the arm attachment end of the second platform support rod, and
wherein the horizontal stepping platform connects to the horizontal side support of the first rod along the first rod side and the horizontal side support of the second rod along the second rod side.

2. The accessory step extender of claim 1, wherein the platform attachment end of the first hanging arm is attached to the arm attachment end of the first platform support rod by threaded bolts forming a first movable joint and the platform attachment end of the second hanging arm is attached to the arm attachment end of the second platform support rod by threaded bolts forming a second movable joint.

3. The accessory step extender of claim 1, further comprising an arm stepping platform lateral support which is connected to and extends between the two respective diagonal hanging extensions near the platform attachment end of each of two side hanging arms.

4. The accessory step extender of claim 3, wherein said arm stepping platform lateral support is further defined by a top edge and a bottom edger, wherein said bottom edge is parallel to the toe side of the horizontal stepping platform.

5. The accessory step extender of claim 1, further comprising a first rung lateral support connected to and extending between the respective vertical interior extensions each of the two side hanging arms.

6. The accessory step extender of claim 1, wherein each diagonal hanging extension is between 13.5 and 14.5 inches

7. The accessory step extender of claim 1, wherein each diagonal hanging extension is 14 inches.

8. The accessory step extender of claim 1, wherein the depth of the horizontal stepping platform as measured from the toe side to the step side is between 9 and 10 inches.

9. The accessory step extender of claim 1, wherein the depth of the horizontal stepping platform as measured from the toe side to the step side is 9.5 inches.

10. The accessory step extender of claim 1, wherein the length of each rod horizontal step overlay is between 2 and 2.3 inches.

11. The accessory step extender of claim 1, wherein the length of each arm horizontal step overlay is between 2 and 2.3 inches,
